(19) United States
(12) Patent Application Publication
(10) Pub. No.: US 2009/0146888 A1
(43) Pub. Date: Jun. 11, 2009

(54) Monopole antenna and wireless network device having the same

(76) Inventor: Jung Tai Wu, Taipei City (TW)

Correspondence Address: Raymond Sun, 12420 Woodhall Way, Tustin, CA, 92782, US

(21) Appl. No.: 12/001,119

(22) Filed: Dec. 10, 2007

(51) Int. Cl. H01Q 1/00; H01Q 1/24

(52) U.S. Cl. 343/702; 343/700 R

(57) ABSTRACT

The present invention discloses a monopole antenna adapted for a wireless network device. The antenna includes a base portion, a ground portion, a radiating portion and a signal portion. The ground portion extends a predetermined height upwardly from the base portion. The radiating portion is connected to an end of the ground portion away from the base portion and is substantially perpendicular to the ground portion. The signal portion is connected to the radiating portion and is substantially and respectively perpendicular to the signal portion and the ground portion. The signal portion has a feed terminal formed on an end thereof away from the radiating portion. A connecting side, where the ground portion and the base portion are connected, has a width that is smaller than a width of another connecting side, where the ground portion and the radiating portion are connected; and a connecting side, where the signal portion and the radiating portion are connected, has a width that is larger than a width of the end of signal portion away from the radiating portion. The antenna is a single component integrally formed by stamping an electrically conductive thin metal plate, which facilitates not only fabrication thereof, but also the assembly of the antenna to a substrate of the wireless network device and increases the gain and bandwidth of the wireless network device along a vertical direction as well.

### BACKGROUND OF INVENTION

1. Field of the Invention

The present invention relates to antennas, and more particularly, to an integrally formed and uni-planar plated ultra wideband (UWB) monopole antenna adapted for use in wireless network devices, and a wireless network device with the antenna.

2. Description of the Prior Art

FIG. 1 is a perspective view of a conventional wireless network device 10 of a wireless network card, for example. The wireless network device 10 usually includes a main body 11, an internal circuit device 12 located inside the main body 11, a connector portion 13 located at one end of the main body 11 for connecting an external mainframe (not shown), and an antenna signal receiving/transmitting portion 14 located at another end of the main body 11 opposing the connector portion 13. Generally, the antenna signal receiving/transmitting portion 14 is provided with a housing that is made of a non-metal material. When the wireless network device 10 is connected to the external mainframe, the antenna signal receiving/transmitting portion 14 must be exposed outside of the external mainframe so as to effectively receive and transmit wireless signals.

FIG. 2 is a schematic view of a conventional internal circuit device 20 of wireless network device. The conventional internal circuit device 20 of the wireless network device includes a substrate 21, a control circuit 22 located on the substrate 21, a ground portion 23 covering a predetermined area of the substrate 21, and an antenna unit 24 electrically connected to the control circuit 22. The conventional antenna unit 24, as illustrated in FIG. 2, includes a first antenna 241 and a second antenna 242 located at two lateral sides of the substrate 21, respectively. Since the antenna unit of this conventional internal circuit device 20 is designed as printed monopole antenna printed on the substrate 21. Due to limitation in height difference along a vertical direction, this type of printed antenna can achieve a better radiation pattern and higher gain on an X-Y plane (horizontal plane) only by designing different shapes of the first antenna 241 and the second antenna 242; but there is almost no further improvement of antenna gain along the vertical Z direction. However, the design of current wireless network device tends to be a vertical stand type, so as to reduce the space occupied by the wireless network device, as well as to make the appearance of the wireless network device more modern and high-tech. It is obvious that the conventional printed antenna cannot meet the requirement for the vertical stand type wireless network device due to the poor gain along the vertical Z direction.

FIG. 3 is a chart showing a radiation pattern measured on an X-Y plane of the first antenna of the conventional printed antenna unit 24 as shown in FIG. 2. From the radiation pattern of FIG. 3, it can be seen that the peak gain value of the first antenna 241 along the vertical direction is only −15.89 dBi, which is apparently lower than the minimum standard acceptable by consumers (a general requirement is that the gain value should be at least higher than −10 dBi). Thus, there are still rooms for improvement regarding to the design of antenna, which is also critically important for meeting consumer's need for high performance antenna.

### SUMMARY OF INVENTION

A first objective of the present invention is to provide a uni-planar plated UWB monopole antenna that facilitates fabrication and reduces cost by using a stamping process to integrally form a uni-planar three-dimensional antenna.

A second object of the present invention is to provide an antenna adapted for use in a wireless network device, which can be quickly assembled to the wireless network device by means of an embedded type design of the antenna, and which has an improved antenna radiation pattern that increases the gain value along a vertical direction and reduces dead spots as well as increases operating bandwidth.

In order to achieve aforementioned objects, the present invention discloses a monopole antenna adapted for a wireless network device. The antenna comprises a base portion, a ground portion, a radiating portion and a signal portion. The ground portion extends a predetermined height upwardly from the base portion. The radiating portion is connected to an end of the ground portion away from the base portion and is substantially perpendicular to the ground portion. The signal portion is connected to the radiating portion and is substantially and respectively perpendicular to the signal portion and the ground portion. The signal portion has a feed terminal formed on an end thereof away from the radiating portion. A connecting side, where the ground portion and the base portion are connected, has a width that is smaller than a width of another connecting side, where the ground portion and the radiating portion are connected; and a connecting side, where the signal portion and the radiating portion are connected, has a width that is larger than a width of the end of signal portion away from the radiating portion. The antenna is a single component integrally formed by stamping an electrically conductive thin metal plate, which facilitates not only fabrication thereof, but also the assembly of the antenna to a substrate of the wireless network device and increases the gain and bandwidth of the wireless network device along a vertical direction as well.

In a preferred embodiment, the connecting side, where the signal portion and the radiating portion are connected, and the connecting side, where the ground portion and the radiating portion are connected, are spaced by a distance rather than directly contacting with each other. Wherein, if the length of distance is d, and the sum of the distance and the connecting side, where the signal portion and the radiating portion are connected, is D, then the relationship between the d and D is D/10<d<D/5. In addition, if the width of the connecting side, where the ground portion and the base portion are connected, is t, and the width of the connecting side, where the ground portion and the radiating portion are connected, is T, then the relationship between t and T is T/5<t<T.

When the antenna of the present invention is utilized in a wireless network device, the wireless network device generally includes a substrate, a control circuit and at least one feed line. The substrate may be made of a dielectric material and may have at least one opening defined thereon. The control circuit is formed on the substrate and may provide a wireless network transmitting function. The feed line is coupled to the control circuit. When the antenna assembles onto the wireless network device, a ground terminal of a base portion of the antenna is inserted into the opening, and the base portion is closely contact with a ground of the substrate. A feed terminal of a signal portion of the antenna is coupled to the feed line. The wireless network device can thus be provided with an improved radiation pattern and a higher gain in the vertical direction as well as a significantly increased the antenna performance.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a perspective view of a typical wireless network device;

FIG. 2 is a schematic view of a conventional internal circuit device of the wireless network device;

FIG. 3 is a chart showing a radiation pattern measured on an X-Y plane of the first antenna of the conventional antenna unit as shown in FIG. 2;

FIG. 4 is a perspective view of a monopole antenna in accordance with a preferred embodiment of the present invention;

FIG. 5A is a front view of the monopole antenna in accordance with the preferred embodiment of the present invention;

FIG. 5B is a left side view of the monopole antenna in accordance with the preferred embodiment of the present invention;

FIG. 5C is a bottom view of the monopole antenna in accordance with the preferred embodiment of the present invention;

FIG. 6 is a schematic view of a wireless network device having the monopole antenna in accordance with the preferred embodiment of the present invention;

FIG. 7A is a chart showing a radiation pattern measured on an X-Y plane of a left monopole antenna adopted with the wideband range of 3.432 GHz in accordance with the present invention as shown in FIG. 6;

FIG. 7B is a chart showing a radiation pattern measured on the X-Y plane of the left monopole antenna adopted with a wideband range of 4.488 GHz in accordance with the present invention as shown in FIG. 6; and

FIG. 8 is a chart showing measurements of input return loss of the monopole antenna of the present invention as shown in FIG. 6.

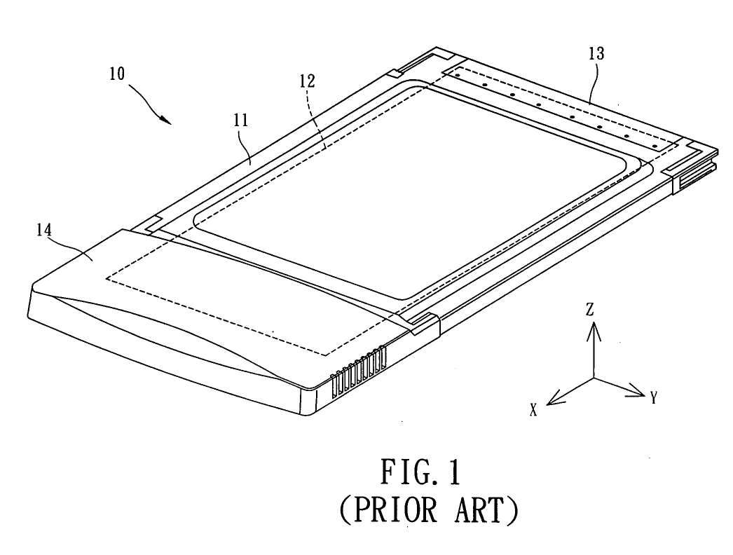

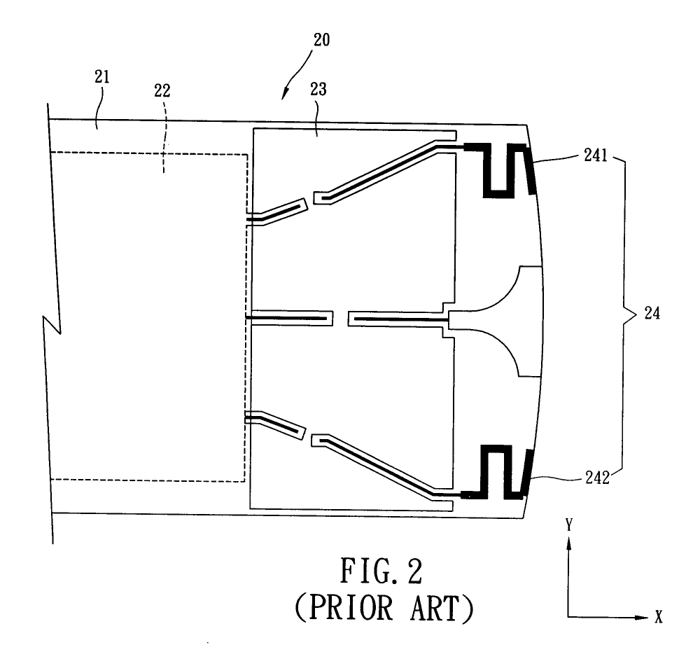

### DETAILED DESCRIPTION

The main principle of the monopole antenna and the wireless network device having the antenna according to the present invention is that a three-dimensional antenna is integrally formed by using a stamping process and the antenna can be quickly assembled to a substrate of the wireless network device. The height difference between a radiating portion and a base portion of the monopole antenna of the present invention can effectively increase the gain along the vertical direction. In addition, the operating bandwidth is widened by means of a ground portion and a signal portion structure; wherein the ground portion has a unique shape as wide top and narrow bottom. Furthermore, by adjusting a distance formed between a connecting side of the signal portion and the radiating portion, and a connecting side of the ground portion and the radiating portion; thus the operating bandwidth can be adjusted so as to adapt the monopole antenna of the present invention for UWB communication protocol. This can not only achieve a higher gain along the vertical direction and a wider operating bandwidth, but also can facilitate fabrication and assembly as well as reducing cost.

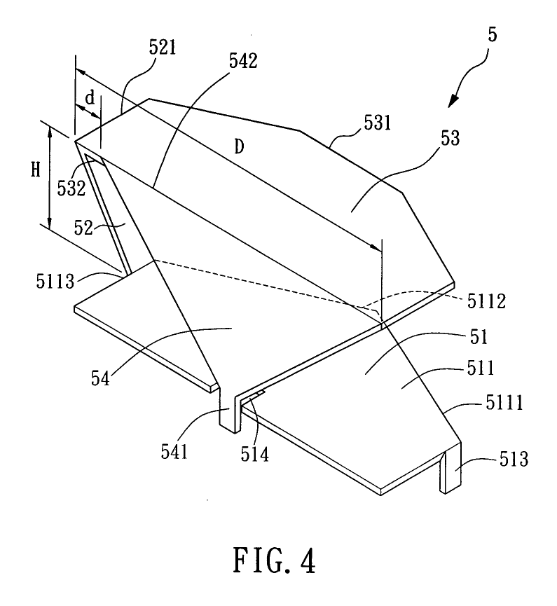

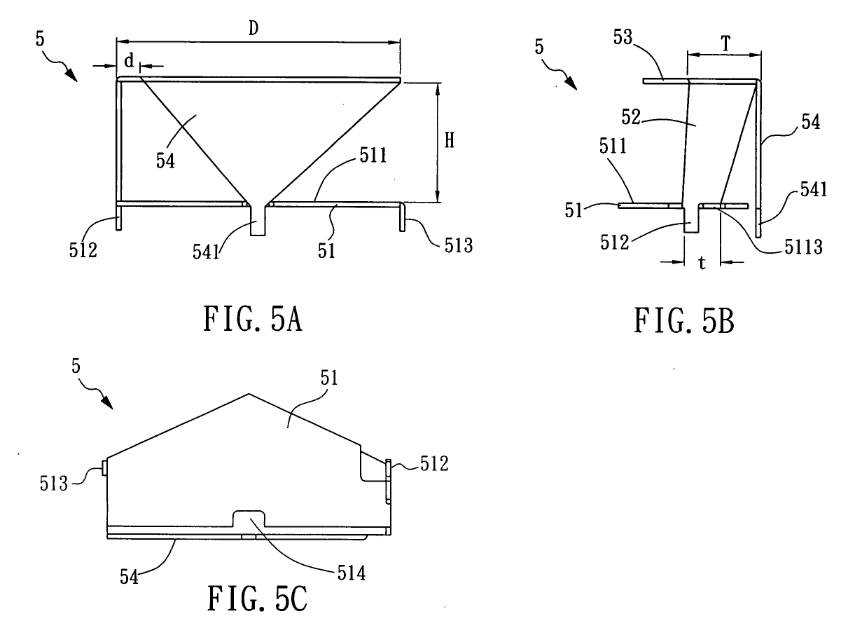

FIG. 4 and FIGS. 5A through 5C are a perspective view and three-views of a UWB monopole antenna in accordance with a preferred embodiment of the present invention, respectively. The UWB monopole antenna 5 of the present invention is a uni-planar plated component integrally formed from bending an electrically conductive thin metal plate (for example, copper, iron, aluminum, tin, gold or alloy thereof and so on) by a stamping process. Therefore, the antenna 5 is of a substantially even thickness, except at the bended areas. The antenna 5 includes a base portion 51, a ground portion 52, a radiating portion 53, and a signal portion 54.

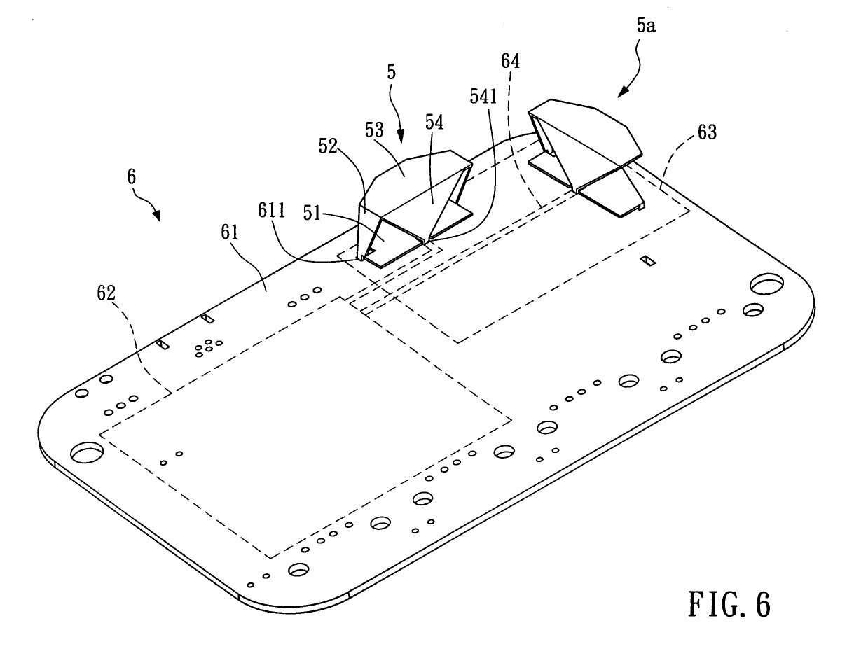

The base portion 51 includes a top surface 511. A side of the base portion 51 away from the signal portion 54 has two bevels 5111, 5112 structured as a triangle shape, such that the entire top surface 511 of the base portion 51 has an approximately pentagonal outline. A contacting point 512 (see FIG. 5B) is formed adjacent to a connecting side 5113 where the base portion 51 and the ground portion 52 are connected, and a ground terminal 513 is also formed on a side of the base portion 51 away from the ground portion 52, for electrically connecting to an external ground, for example, a ground 63 located on a substrate 61 of a wireless network device 6 (as shown in FIG. 6). In addition, the base portion 51 has an inwardly extended cutout 514 positioned corresponding to a feed terminal 541 on a bottom end of the signal portion 54, allowing the feed terminal 541 to extend to below the base portion 51 without contacting the base portion 51. A bottom end of the ground portion 52 is connected to the top surface 511 of the base portion 51, and the ground portion 52 extends upwardly with a predetermined height H substantially perpendicular to the top surface 511 of the base portion 51. The connecting side 5113, where the ground portion 52 and the base portion 51 are connected, has a width t that is smaller than a width T of another connecting side 521, where the ground portion 52 and the radiating portion 53 are connected, such that the ground portion 52 is substantially structured to have a wide top and a narrow bottom. In this embodiment, T/5<t<T, 2 mm<T<8 mm, and 4 mm<H<12 mm. By controlling the predetermined height H can increase the gain along the vertical direction of the monopole antenna 5 of the present invention and reduce dead spots. The ground portion 52 with wide top and narrow bottom can increase the operating bandwidth of the monopole antenna 5 of the present invention.

A lateral side of the radiating portion 53 is connected to the connecting side 521 of the ground portion 52 away from the base portion 51, and the radiating portion 53 extends substantially horizontally with a predetermined length D from the ground portion 52. Therefore, the radiating portion 53 is substantially perpendicular to the ground portion 52, and substantially parallel to the top surface 511 of the base portion 51. A projection of the radiating portion 53 along the vertical direction is substantially located within the outline of the top surface 511 of the base portion 51. A side of the radiating portion 53 away from the signal portion 54 has a gradually narrowed trapezoid outline 531, such that the top surface of the radiating portion 53 is constructed as a hexagon.

A connecting side 542 of the signal portion 54 on a top end thereof is connected to the radiating portion 53, and the signal portion 54 extends downward from the radiating portion 53 with a predetermined height, such that the feed terminal 541 on the bottom end (i.e. the end of the signal portion 54 away from the radiating portion 53) of the signal portion 54 is positioned to be slightly lower than the base portion 51. Therefore, the signal portion 54 is substantially perpendicular to each of the radiating portion 53, the ground portion 52 and the base portion 51. The connecting side 542, where the signal portion 54 and the radiating portion 53 are connected, has a width that is larger than the width of the end (i.e. the feed terminal 541) of the signal portion 54 away from the radiating portion 53, such that the signal portion 54 is substantially structured to have a wide top and a narrow bottom. The signal portion 54 with wide top and narrow bottom likewise can increase the operating bandwidth of the monopole antenna 5 of the present invention. In addition, the connecting side 542, where the signal portion 54 and the radiating portion 53 are connected, and the connecting side 521, where the ground portion 52 and the radiating portion 53 are connected, are spaced by a distance 532 rather than directly contacting each other. By adjusting the length of distance 532 can adjust and control the operating bandwidth of the monopole antenna 5 of the present invention such that the monopole antenna 5 can meet the operating bandwidth requirements in accordance with UWB communication protocol. In this embodiment, if the length of distance 532 is d, and the sum of the distance 532 and the connecting side 542, where the signal portion 54 and the radiating portion 53 (i.e. the total length of the radiating portion 53 extends horizontally) are connected, is D, then the relationship between the d and D is D/10<d<D/5, wherein 12 mm<D<24 mm.

FIG. 6 is a schematic view showing a preferred embodiment of an internal circuit device of a wireless network device with the monopole antenna of the present invention. The wireless network device 6 of the present invention includes a substrate 61, a control circuit 62, a ground 63, at least one feed line 64, and at least one monopole antenna 5, 5a of the present invention. The substrate 61 is made of a dielectric material and made into a substantially plano-rectangular substrate 61. The substrate 61 has a plurality of openings 611 defined therein. The ground 63 functions to electrically connect to ground (GND) and covers areas where the monopole antennas 5, 5a are located. The control circuit 62 is formed on the substrate 61, including a circuit layout, a plurality of IC components and electronic components, and is capable of providing wireless network transmitting function in accordance with UWB communication protocol. The control circuit 62 may use conventional technology and is not a main feature of the present invention; therefore, the configuration of the control circuit 62 is not described hereinafter.

In this preferred embodiment, most components of the antenna 5, 5a are the same as or similar to those in the foregoing embodiments and, therefore, same components will be given same names and same reference numbers. The antennas 5, 5a are two objects and the antennas 5, 5a are positioned on the substrate 61 with one being substantially perpendicular to the other. The amount of the antenna(s) 5 can be one or other amount when desired and the antennas 5 can be arranged on the substrate 61 at predetermined locations or in predetermined patterns, which are not main features of the present invention and thus not described hereinafter. In the antenna 5, the contacting point 512, ground terminal 513, and feed terminal 541 are positioned respectively on the corresponding openings 611 and, therefore, when the terminals 512, 513, 541 at the bottom of the antenna 5 are inserted into corresponding openings 611, the base portion 51 is closely contact with the top surface of the substrate 61, with the feed terminal 541 being coupled to the feed line 64 and the feed line 64 being coupled to the control circuit 62, thereby providing the signal transmission function.

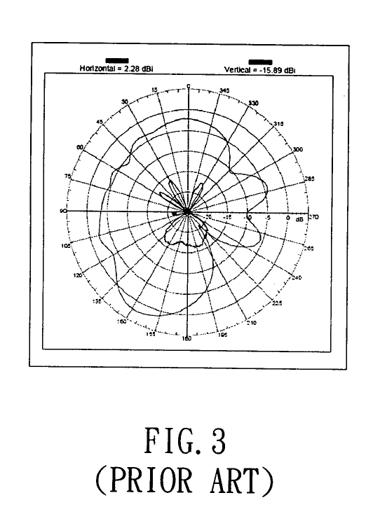

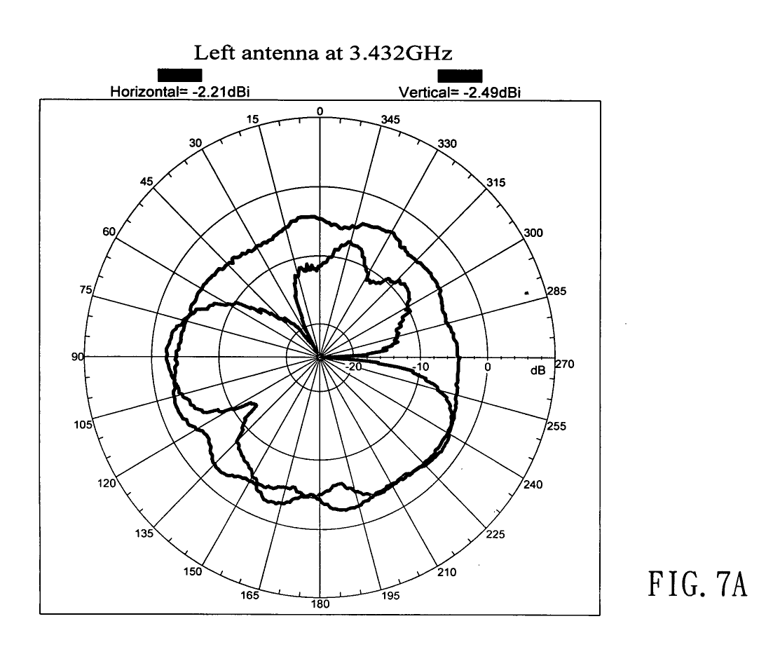

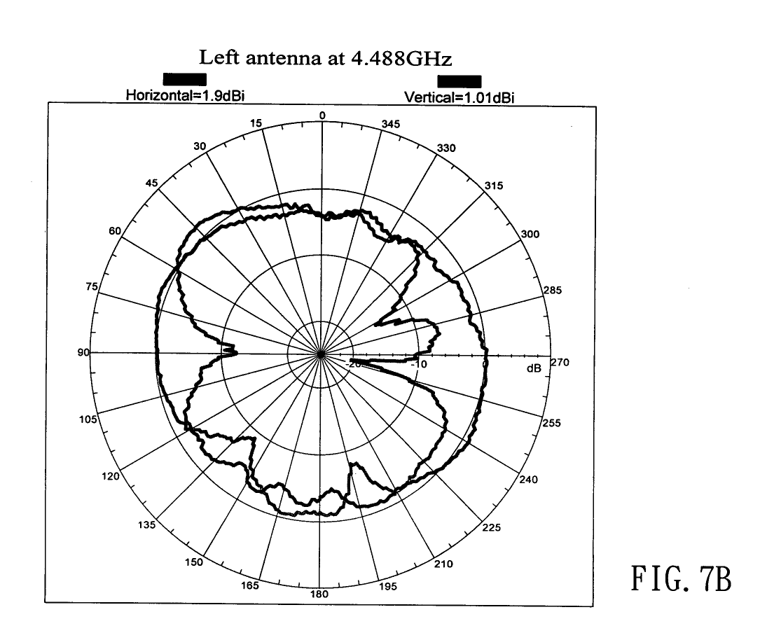

FIGS. 7A and 7B are charts showing radiation patterns measured on an X-Y plane of the left antenna adopted respectively with wideband ranges of 3.432 GHz and 4.488 GHz of the present invention as shown in FIG. 6. From the radiation pattern of FIG. 7A, it can be seen that, when the left antenna 5 is adopted for wideband range (3.432 GHz), the gain of the left antenna 5 along the vertical direction can be as high as −2.49 dBi; and from the radiation pattern of FIG. 7B, it can be seen that, when the left antenna 5 is adopted for wideband range (4.488 GHz), the gain of the left antenna 5 along the vertical direction can be as high as 1.01 dBi, which is apparently much higher than the gain −15.89 dBi of the conventional technology as shown in FIG. 3.

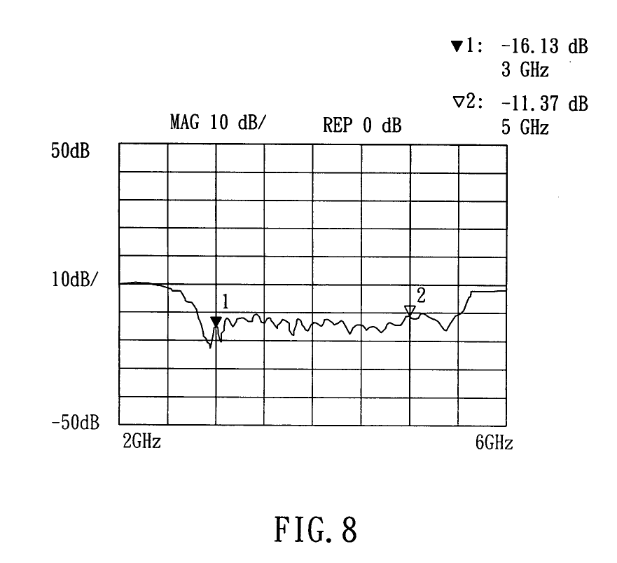

FIG. 8 is a chart showing measurements of input return loss of the antenna of the present invention as shown in FIG. 6. From FIG. 8, it can be seen that, when the antenna of the present invention is adopted for bandwidth from 3 GHz to 5 GHz, the input return loss of the antenna is approximately in the range from −16.13 dBi to −11.37 dBi, all of which are less than −10 dB and meet the market needs for antenna design with high performance. It is to be understood that in addition to the capability of providing better wireless communication quality and transmission efficiency along the vertical direction than conventional technologies, the operating bandwidth from 3 GHz to 5 GHz is also wider than the conventional technologies. Furthermore, the antenna 5 of the present invention can facilitate fabrication and reduce costs by using the stamping process to integrally form the uni-planar plated three-dimensional antenna. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A monopole antenna adapted for a wireless network device, the antenna comprising:
a base portion having a top surface;
a ground portion having one end connected to the top surface of the base portion, and extending upwardly with a predetermined height substantially perpendicular to the top surface of the base portion;
a radiating portion having one end connected to an end of the ground portion away from the base portion, the radiating portion being substantially perpendicular to the ground portion and substantially parallel to the top surface of the base portion; and
a signal portion connected to the radiating portion, the signal portion being substantially perpendicular to each of the radiating portion, the ground portion and the base portion, the signal portion having a feed terminal formed on an end thereof away from the radiating portion.

2. The monopole antenna in accordance with claim 1, wherein the monopole antenna is a single three-dimensional component integrally formed by stamping an electrically conductive thin metal plate.

3. The monopole antenna in accordance with claim 1, wherein a connecting side, where the ground portion and the base portion are connected, has a width that is smaller than a width of another connecting side, where the ground portion and the radiating portion are connected, such that the ground portion is substantially structured to have a wide top and a narrow bottom.

4. The monopole antenna in accordance with claim 3, wherein a connecting side, where the signal portion and the radiating portion are connected, has a width that is larger than a width of the end of signal portion away from the radiating portion, such that the signal portion is substantially structured to have a wide top and a narrow bottom.

5. The monopole antenna in accordance with claim 4, wherein the connecting side, where the signal portion and the radiating portion are connected, and the connecting side, where the ground portion and the radiating portion are connected, are spaced by a distance rather than directly contacting with each other.

6. The monopole antenna in accordance with claim 5, wherein if the length of said distance is d, and the sum of the distance and the connecting side, where the signal portion and the radiating portion are connected, is D, then the relationship between the d and D is D/10<d<D/5; in addition, if the width of the connecting side, where the ground portion and the base portion are connected, is t, and the width of the connecting side, where the ground portion and the radiating portion are connected, is T, then the relationship between t and T is T/5<t<T.

7. The monopole antenna in accordance with claim 6, wherein a predetermined height of the ground portion is H, and wherein 4 mm<H<12 mm, 12 mm<D<24 mm, and 2 mm<T<8 mm.

8. The monopole antenna in accordance with claim 1, wherein a projection of the radiating portion along a vertical direction is substantially located within an outline of the top surface on the base portion, and a side of the radiating portion away from the signal portion has a gradually narrowed trapezoid outline.

9. The monopole antenna in accordance with claim 8, wherein a side of the base portion away from the signal portion has two bevels structured as triangle shape, and the base portion has a cutout positioned corresponding to the feed terminal, allowing the feed terminal to extend to below the base portion without contacting the base portion.

10. The monopole antenna in accordance with claim 1, wherein at least a contacting point is formed adjacent to the connecting side where the base portion and the ground portion are connected, the contacting point being configured to electrically connect to a ground of the wireless network device.

11. A monopole antenna, comprising:
a base portion;
a ground portion extending a predetermined height upwardly from the base portion;
a radiating portion connected to an end of the ground portion away from the base portion, the radiating portion being substantially perpendicular to the ground portion; and
a signal portion connected to the radiating portion, and being substantially perpendicular to the signal portion and the ground portion, the signal portion having a feed terminal formed on an end thereof away from the radiating portion;
wherein a connecting side, where the ground portion and the base portion are connected, has a width that is smaller than a width of another connecting side, where the ground portion and the radiating portion are connected; and a connecting side, where the signal portion and the radiating portion are connected, has a width that is larger than a width of the end of signal portion away from the radiating portion.

12. The monopole antenna in accordance with claim 11, wherein the connecting side, where the signal portion and the radiating portion are connected, and the connecting side, where the ground portion and the radiating portion are connected, are spaced by a distance rather than directly contacting with each other.

13. The monopole antenna in accordance with claim 12, wherein if the length of distance is d, and the sum of the distance and the connecting side, where the signal portion and the radiating portion are connected, is D, then the relationship between the d and D is D/10<d<D/5; in addition, if the width of the connecting side, where the ground portion and the base portion are connected, is t, and the width of the connecting side, where the ground portion and the radiating portion are connected, is T, then the relationship between t and T is T/5<t<T; moreover, if a predetermined height of the ground portion is H, then 4 mm<H<12 mm, 12 mm<D<24 mm, and 2 mm<T<8 mm.

14. The monopole antenna in accordance with claim 13, wherein at least a contacting point is formed adjacent to the connecting side where the base portion and the ground portion are connected, the contacting point being configured to electrically connect to a ground of a substrate.

15. A wireless network device, comprising:
a substrate made of a dielectric material, the substrate having a plurality of openings defined therein and comprising a ground electrically connected to ground;
a control circuit formed on the substrate and configured to provide wireless network transmitting function;
at least one feed line coupled to the control circuit; and
at least one antenna located within an area of the ground, the antenna further comprising:
a base portion electrically connected to a ground;
a ground portion extending a predetermined height upwardly from the base portion;
a radiating portion connected to an end of the ground portion away from the base portion, the radiating portion being substantially perpendicular to the ground portion; and
a signal portion connected to the radiating portion, and being substantially and respectively perpendicular to the signal portion and the ground portion, the signal portion having a feed terminal formed on an end thereof away from the radiating portion;
wherein a connecting side, where the ground portion and the base portion are connected, has a width that is smaller than a width of another connecting side, where the ground portion and the radiating portion are connected, and a connecting side, where the signal portion and the radiating portion are connected, has a width that is larger than a width of the end of signal portion away from the radiating portion.

16. The wireless network device in accordance with claim 15, wherein the monopole antenna is a single three-dimensional component integrally formed by stamping an electrically conductive thin metal plate.

17. The wireless network device in accordance with claim 15, wherein the connecting side, where the signal portion and the radiating portion are connected, and the connecting side, where the ground portion and the radiating portion are connected, are spaced by a distance rather than directly contacting with each other.

18. The wireless network device in accordance with claim 17, wherein if the length of distance is d, and the sum of the distance and the connecting side, where the signal portion and the radiating portion are connected, is D, then the relationship between the d and D is D/10<d<D/5; in addition, if the width of the connecting side, where the ground portion and the base portion are connected, is t, and the width of the connecting side, where the ground portion and the radiating portion are connected, is T, then the relationship between t and T is T/5<t<T; moreover, if a predetermined height of the ground portion is H, then 4 mm<H<12 mm, 12 mm<D<24 mm, and 2 mm<T<8 mm.

19. The wireless network device in accordance with claim 18, wherein at least a contacting point is formed adjacent to the connecting side where the base portion and the ground portion are connected, the contacting point being configured to electrically connect to the ground of the substrate.
